(19) United States
(12) Patent Application Publication
(10) Pub. No.: US 2024/0380217 A1
(43) Pub. Date: Nov. 14, 2024

(54) Intelligent Charger With Battery Charging And Discharging Maintenance Unattended For long Time

(71) Applicant: Shenzhen Tuozheng Technology Co., Ltd., Shenzhen (CN)

(72) Inventors: Zhanke Cui, Shenzhen (CN); Kelei Cui, Xinyi (CN)

(21) Appl. No.: 18/413,151

(22) Filed: Jan. 16, 2024

(30) Foreign Application Priority Data
May 11, 2023 (CN) 2023211286740

(51) Int. Cl. H02J 7/00

(52) U.S. Cl. CPC H02J 7/00038

(57) ABSTRACT

An intelligent charger with battery charging and discharging maintenance unattended for long time is disclosed, including, a charging regulation module, configured to regulate charging; a first feedback module and a second feedback module, configured to provide feedback signals; an output module, configured to transmit electrical energy; a battery identification module, configured to identify battery type; an intelligent control module, configured to receive signals and control modules; a feedback regulation module, configured to regulate amplitude of feedback signals; a battery maintenance module, configured to cooperate with a charging control module to automatically control charging capacity; a manual regulation module, configured to cooperate with the charging control module to manual control the charging capacity; and a communication module, configured to establish a wireless communication network with the intelligent control module and can interact with the intelligent control module for data. The battery maintenance module can perform a long-term charging maintenance.

### TECHNICAL FIELD

The present application relates to the technical field of chargers and more specifically to an intelligent charger with battery charging and discharging maintenance unattended for long time.

### BACKGROUND

With continuous development of portable electric devices, in order to ensure that the portable electric devices have an extended battery life, a specific charger for charging may be required. Existing chargers are only simply used for charging specific batteries, its intelligence is low, and such chargers may not effectively provide corresponding charging modes based on types of the batteries, thus charging efficiency is low and not widely available. Moreover, the chargers have poor maintenance effect on the batteries, often due to the maintenance is not in place, causing damages to the batteries and economic losses to customers. Thus, the chargers need to be improved.

### SUMMARY

The present disclosure aims to provide an intelligent charger with battery charging and discharging maintenance unattended for long time to address problems mentioned in the background.

In some embodiments of the present disclosure, an intelligent charger with battery charging and discharging maintenance unattended for long time is provided, including a charging regulation module, a first feedback module, an output module, a charging control module, a second feedback module, a battery identification module, an intelligent control module, a feedback regulation module, a battery maintenance module, and a manual regulation module.

In some embodiments of the present disclosure, the charging regulation module is configured to receive electrical energy, and a signal fed back from the first feedback module, and to perform a DC-DC regulation process on input electrical energy based on a feedback signal.

In some embodiments of the present disclosure, the first feedback module is connected to the charging regulation module and configured to transmit electrical energy output from the charging regulation module and sample voltage and current of a transmitted electrical energy for outputting the first feedback signal.

In some embodiments of the present disclosure, the output module is connected to the first feedback module and configured to receive electrical energy output from the first feedback module and transmit it to an electric device connected to the output module.

In some embodiments of the present disclosure, the second feedback module is connected to the output module and configured to sample electrical energy of the output module in terms of voltage and output a second feedback signal.

In some embodiments of the present disclosure, the battery identification module is connected to the output module and configured to, for the electric device connected to the output module, perform battery identification and output battery type information.

In some embodiments of the present disclosure, the intelligent control module is connected to the feedback regulation module, the battery identification module, the second feedback module and the battery maintenance module. And the intelligent control module is configured to, output a first pulse signal, a second pulse signal and a third pulse signal; select a pulse pattern to be input into the feedback regulation module based on battery type information received; receive the second feedback signal; determine electrical energy condition of the electric device connected to the output module; set clock information; output a fourth pulse signal; and control operation of the battery maintenance module based on the clock information.

In some embodiments of the present disclosure, the feedback regulation module is connected to the first feedback module and configured to output a feedback regulation signal; change amplitude of the first feedback signal output by the first feedback module; receive the first pulse signal, the second pulse signal and the third pulse signal; and regulate amplitude of feedback signals.

In some embodiments of the present disclosure, the battery maintenance module is connected to the second feedback module, and configured to, via a battery maintenance circuit, compare the second feedback signal and the fourth pulse signal those received, and output a first control signal.

In some embodiments of the present disclosure, the manual regulation module is connected to the second feedback module and configured to manually adjust a battery threshold, compare a set battery threshold with the second feedback signal, and output a second control signal.

In some embodiments of the present disclosure, the charging control module is connected to the battery maintenance module and the manual regulation module, and configured to receive the first control signal and the second control signal, and control the DC-DC regulation process of the charging regulation module.

In some embodiments of the present disclosure, the intelligent charger with battery charging and discharging maintenance unattended for long time further includes a communication module.

In some embodiments of the present disclosure, the communication module is configured to establish a wireless communication network with the intelligent control module and can interact with the intelligent control module for data.

In some embodiments of the present disclosure, the communication module is connected with the intelligent control module.

Compared with existing technologies, the present disclosure has at least following advantages. The intelligent charger with battery charging and discharging maintenance unattended for long time of the present disclosure can achieve identifications of types of the batteries of the electric device connected to the output module through the battery identification module and the intelligent control module, so that the intelligent control module, based on the identified battery type information, can control the feedback regulation module and change feedback information values of the charging regulation module inputted by the first feedback module. Then a DC-DC regulation is performed by the charging regulation module to provide a desired charging electrical energy for the types of the batteries identified, a desired battery power may be freely set by the manual regulation module. The intelligent control module can cooperate with the battery maintenance module to perform charging maintenance on the electric device connected for long time, and maintains the battery power of the electric device within a set maintenance electrical energy range based on the types of the batteries identified. By such designs, application ranges and intelligence of the charger can be improved; the charge therefore can have excellent charging efficiency, high safety and also can extend the life of the batteries of the electric device.

### BRIEF DESCRIPTION OF THE DRAWINGS

In order to more clearly illustrate the technical solutions of the embodiments of the present disclosure, accompanying drawings to be used in the description of the embodiments of the present disclosure will be briefly introduced below, and it will be obvious that the accompanying drawings in the following description are one part of the embodiments of the present disclosure, and that for a person of ordinary skill in the art, other accompanying drawings may be obtained according to these drawings without creative labor.

FIG. 1 illustrates a block schematic diagram of principle of an intelligent charger with battery charging and discharging maintenance unattended for long time in accordance with some embodiments of the present disclosure.

FIG. 2 illustrates a circuit diagram of an intelligent charger with battery charging and discharging maintenance unattended for long time in accordance with some embodiments of the present disclosure.

FIG. 3 illustrates a connection circuit diagram of a battery maintenance module in accordance with some embodiments of the present disclosure.

### DETAILED DESCRIPTION OF THE EMBODIMENTS

The technical solutions in the embodiments of the present disclosure will be described clearly and completely below in conjunction with accompanying drawings in the embodiments, and it is obvious that the described embodiments are only a part of the embodiments of the present disclosure and not all of the embodiments. Based on the embodiments in the present disclosure, all other embodiments obtained by the person of ordinary skill in the art without making creative labor are within the scope of the protection of the present invention.

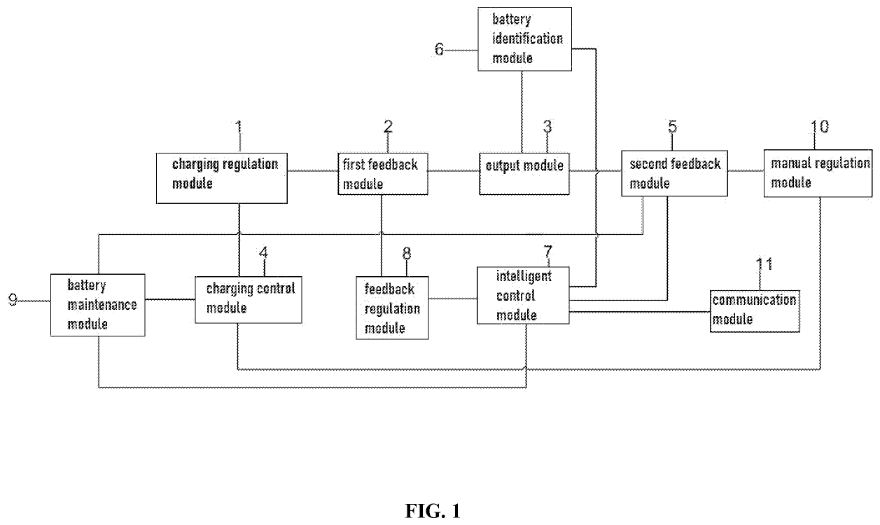

In some embodiments of the present disclosure, referring to FIG. 1, an intelligent charger with battery charging and discharging maintenance unattended for long time is provided, including a charging regulation module 1, a first feedback module 2, an output module 3, a charging control module 4, a second feedback module 5, a battery identification module 6, an intelligent control module 7, a feedback regulation module 8, a battery maintenance module 9, and a manual regulation module 10.

Specifically, the charging regulation module 1 is configured to receive electrical energy, and a signal fed back from the first feedback module 2, and to perform a DC-DC regulation process on input electrical energy based on a feedback signal.

The first feedback module 2 is connected to the charging regulation module 1 and configured to transmit electrical energy output from the charging regulation module 1 and sample voltage and current of a transmitted electrical energy for outputting the first feedback signal.

The output module 3 is connected to the first feedback module 2 and configured to receive electrical energy output from the first feedback module 2 and transmit it to an electric device connected to the output module 3.

The second feedback module 5 is connected to the output module 3 and configured to sample electrical energy of the output module 3 in terms of voltage and output a second feedback signal.

The battery identification module 6 is connected to the output module 3 and configured to, for the electric device connected to the output module 3, perform battery identification and output battery type information.

The intelligent control module 7 is connected to the feedback regulation module 8, the battery identification module 6, the second feedback module 5 and the battery maintenance module 9. And the intelligent control module 7 is configured to, output a first pulse signal, a second pulse signal and a third pulse signal; select a pulse pattern to be input into the feedback regulation module 8 based on the battery type information received; receive the second feedback signal; determine electrical energy condition of the electric device connected to the output module 3; set clock information; output a fourth pulse signal; and control operation of the battery maintenance module 9 based on the clock information.

The feedback regulation module 8 is connected to the first feedback module 2 and configured to, output a feedback regulation signal; change amplitude of the first feedback signal output by the first feedback module 2; receive the first pulse signal, the second pulse signal and the third pulse signal; and regulate amplitude of feedback signals.

The battery maintenance module 9 is connected to the second feedback module 5, and configured to, via a battery maintenance circuit, compare the second feedback signal and the fourth pulse signal those received, and output a first control signal.

The manual regulation module 10 is connected to the second feedback module 5 and configured to manually adjust a battery threshold, compare a set battery threshold with the second feedback signal, and output a second control signal.

The charging control module 4 is connected to the battery maintenance module 9 and the manual regulation module 10, and configured to receive the first control signal and the second control signal, and control the DC-DC regulation process of the charging regulation module 1.

In some preferred embodiments of the present disclosure, the intelligent charger with battery charging and discharging maintenance unattended for long time further includes a communication module 11.

Specifically, the communication module 11 is configured to establish a wireless communication network with the intelligent control module 7 and can interact with the intelligent control module 7 for data.

The communication module 11 is connected with the intelligent control module 7.

In some specific embodiments of the present disclosure, the charging regulation module 1 may use a charging regulation circuit to regulate input electrical energy based on the input feedback information, so as to provide a desired charging electrical energy. The first feedback module 2 may use a current sampling circuit and a voltage sampling circuit to provide current information and voltage information for the charging regulation module 1, i.e., the first feedback signal, respectively. The output module 3 may use a device connection port to connect with the battery of the electric device. The charging control module 4 may use a charging control circuit consist of a triode circuit, controlled by the battery maintenance module 9 and the manual regulation module 10, to control a charging state of the charging regulation module 1. The second feedback module 5 may use a voltage detection circuit to detect the electrical energy of the output module 3 and the battery power of the electric device connected to the output module 3, so as to provide voltage information, i.e., the second feedback signal. The battery identification module 6 may use a battery identification circuit and cooperate with the intelligent module 7 to identify battery type information of the electric device connected to the output module 3. The intelligent control module 7 may use a micro-control circuit and a clock circuit, herein the micro-control circuit may include, but not limited to, MCU and components integrated with elements, such as operators, controllers, memories, inputs and outputs, and controllers capable of realizing functions of processing signals, data storage, module control, and timed control. The clock circuit may use a clock device, to provide a clock signal for the micro-control circuit. The feedback regulation module 8 may use a feedback regulation circuit, to regulate amplitude of the first feedback signal output by the first feedback signal based on signals output by the intelligent control module 7. The battery maintenance module 9 may use a battery maintenance circuit, controlled by the intelligent control module 7, to complete charging protection control of the electric device with long time charging. The manual regulation module 10 may use a manual regulation circuit to realize manual charging capacity control by manually controlling operation of the charging control module 4. The communication module 11 may use a Bluetooth communication device to control the intelligent control module 7 to establish a wireless communication network with the intelligent mobile device, and through relevant APPs (application programs) in an intelligent mobile device (herein the communication module 11 can not only be connected via the Bluetooth, but also can be connected to wifi, or plug in a network cable, or insert a SIM card directly connected to the network), a user may be informed of working status of the charger, that is, current charge, voltage, temperature, charging current, charging voltage, estimated charging time, etc., specifics will not be described in detail.

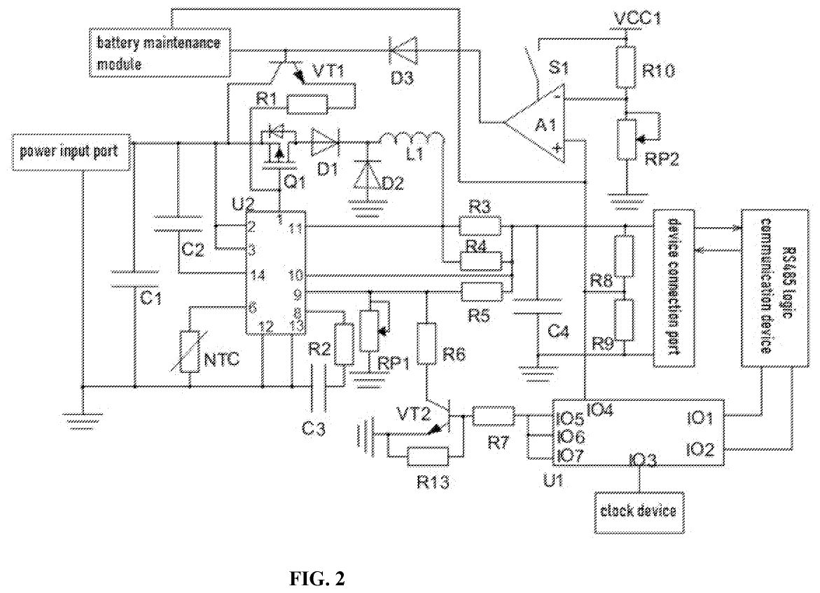

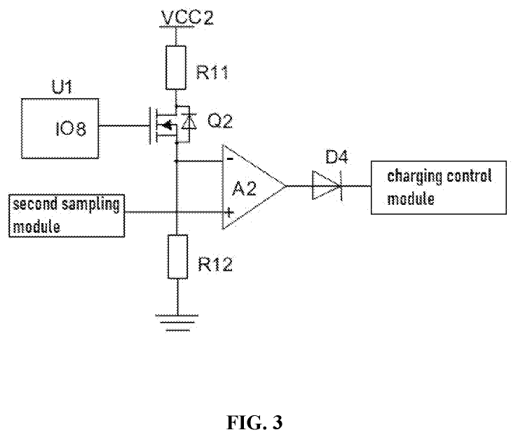

In some other embodiments of the present disclosure, referring to FIG. 1, FIG. 2, and FIG. 3, the charging regulation module 1 includes a power input port, a first capacitor C1, a second capacitor C2, a thermistor NTC, a first regulator U2, a first power tube Q1, a first diode D1, a second diode D2, a first inductor L1, a second resistor R2, and a third capacitor C3.

Specifically, a first end of the power input port is connected to one end of the first capacitor C1, one end of the second capacitor C2, a source of the first power tube Q1, a second end and a third end of the first regulator U2. The other end of the second capacitor C2 is connected to a fourteenth end of the first regulator U2. A six end of the first regulator U2 is grounded via the thermistor NTC, and an eighth end of the first regulator U2 is grounded via the second resistor R2 and the third capacitor C3 in turn. A grid of the first power tube Q1 is connected to a first end of the first regulator U2, a drain of the first power tube Q1 is connected to an anode of the first diode D1, and a cathode of the first diode D1 is connected to a cathode of the second diode D2 and a first end of the first inductor L1. A second end of the first inductor L1 is connected to an eleventh end of the first regulator U2 and to the first feedback module 2. A second end of the power input port, the other end of the first capacitor C1, and a twelfth end and a thirteenth end of the first regulator U2 are grounded. An anode of the second diode D2 is grounded.

In some specific embodiments of the present disclosure, the first regulator U2 may use a SLM 6900 charging device, which cooperates with the first power tube Q1, the first diode D1, the second diode D2, the first inductor L1, the second capacitor C2, the second resistor R2, the thermistor NTC and the third capacitor C3 based on the fed back signal, to regulate the input electrical energy. The thermistor NTC provides temperature information for the first regulator U2 to realize an over-temperature protection of the first regulator U2. The first power tube Q1 may use a P-channel enhancement MOS tube, which is controlled the first regulator U2 to realize the regulation of electrical energy.

In some preferred embodiments of the present disclosure, the first feedback module 2 includes a third resistor R3, a fourth resistor R4, a fifth resistor R5, and a first potentiometer RP1. The output module 3 includes a fourth capacitor C4 and a device connection port.

In some specific embodiments of the present disclosure, a first end of the third resistor R3 is connected to one end of the fourth resistor R4 and an eleventh end of the first regulator U2. A second end of the third resistor R3 is connected to one end of the fourth resistor R4, a tenth end of the first regulator U2, a first end of the fifth resistor R5, one end of the fourth resistor C4, and a first end of the device connection port. A second end of the fifth resistor R5 is connected to a ninth end of the first regulator U2, one end of the first potentiometer RP1, and a slider. The other end of the first potentiometer RP1, the other end of the fourth capacitor C4, and a second end of the device connection port are grounded.

In some specific embodiments of the present disclosure, the third resistor R3 and the fourth resistor R4 are configured to detect current, the fifth resistor R5 and the first potentiometer RP1 is configured to detect voltage. The device connection port is configured to connect the battery of the electric device, and the battery of the electric device may be a lead-acid battery, a ternary lithium battery, a lithium iron phosphate battery and so on, the specific do not go into details.

In some specific embodiments of the present disclosure, the battery identification module 6 includes a RS485 logic communication device, the intelligent control module 7 includes a first controller U1 and a clock device, and the second feedback module 5 includes an eighth resistor R8 and a ninth resistor R9.

In some specific embodiments of the present disclosure, the RS485 logic communication device is configured to identify device battery information connected to the device connection port and connected to a first IO end and a second IO end of the first controller U2. The clock device is connected to a third IO end of the first controller U1. One end of the eighth resistor R8 is connected to the first end of the device connection port, the other end of the eighth resistor R8 is connected to a fourth IO end of the first controller U1 and grounded via the ninth resistor.

In some specific embodiments of the present disclosure, the RS485 logic communication device is configured to identify the battery type information of the electric device connected to the device connection port, and transmit it to the first controller U1, its specific modes will not be described in detail. The first controller U1 may use, but not limited to, a MCU controller composed of STM32. The clock device provides clock information for the first controller U1, so that the first controller U1 can determine whether a charging time of the battery of the electric device connected to the device connection port is too long or not, herein will not described in detail. The eighth resistor R8 and the ninth resistor R9 are configured to sample electrical energy input to the device connection port and battery power of the electric device connected to the device connection port.

In some preferred embodiments of the present disclosure, the feedback regulation module 8 includes a seventh resistor R7, a sixth resistor R6, a thirteenth resistor R13, and a second switch tube VT2.

In some specific embodiments of the present disclosure, one end of the seventh resistor R7 is connected to the first IO end, the second IO end, and the third IO end of the first controller U1, the other end of the seventh resistor R7 is connected to a first end of the thirteenth resistor R13 and a base of the second switch tube VT2. An emitter of the second switch tube VT2 and a second end of the thirteenth resistor R13 are grounded, and a collector of the second switch tube VT2 is connected to a second end of the fifth resistor R5 via the sixth resistor R6.

In some specific embodiments of the present disclosure, the second switch tube VT2 may use a NPN-type transistor, which cooperates with the seventh resistor R7, the sixth resistor R6 and the thirteenth resistor R13 to adjust the amplitude of feedback signals input into the first regulator U2.

In some preferred embodiments of the present disclosure, the manual regulation module 10 includes a first power supply VCC1, a tenth resistor R10, a second potentiometer RP2, a first key switch S1, a first comparator A1, and a third diode D3. The charging control module 4 includes a first resistor R1 and a first switch tube VT1.

In some specific embodiments of the present disclosure, the first power supply VCC1 is connected to one end of the first key switch S1, and connected to an inverting end of the first comparator A1, one end of the second potentiometer RP2 and the slider via the tenth resistor R10. And the other end of second potentiometer RP2 is grounded. A non-inverting end of the first comparator A1 is connected to a second end of the eighth resistor R8, a power supply end of the first comparator A1 is connected to the other end of the first key switch S1, an output of the first comparator A1 is connected to an anode of the third diode D3, and a cathode of the third diode D3 is connected to a base of the first switch tube VT1. An emitter of the first switch tube VT1 is connected to a grid of the first power tube Q1 via the first resistor, and a collector of the first switch tube VT1 is connected to a source of the first power tube Q1.

In some specific embodiments of the present disclosure, the first comparator A1 may be an LM393 comparator. The tenth resistor R10, the second potentiometer RP2 and the first power supply VCC1 are configured to provide a desired battery threshold and be regulated the second potentiometer RP2.

In some preferred embodiments of the present disclosure, the battery maintenance module 9 includes a second power supply VCC2, an eleventh resistor R11, a second power tube Q2, a twelfth resistor R12, a second comparator A2, and a fourth diode D4.

In some specific embodiments of the present disclosure, the second power supply VCC2 is connected to a drain of the second power tube Q2 via the eleventh resistor R11, a grid of the second power tube Q2 is connected to an eighth IO end of the first controller U1, and a source of the second power tube Q2 is connected to an inverting end of the second comparator A2 and grounded via the twelfth resistor R12. A non-inverting end of the second comparator A2 is connected to a second end of the eighth resistor R8, an output of the second comparator A2 is connected to an anode of the fourth diode D4, and a cathode of the fourth diode D4 is connected to a base of the first switch tube VT1.

In some specific embodiments of the present disclosure, the second power tube Q2 may be an N-channel enhancement MOS tube, which cooperates with the eleventh resistor R11, the second power supply VCC2 and the twelfth resistor R12 to provide a maintenance battery threshold for the second comparator A2, and may be adjusted by the second power tube Q2 for the battery threshold. The second comparator A2 may be an LLM393 comparator.

The intelligent charger with battery charging and discharging maintenance unattended for long time of the present disclosure, the power input port is connected to a DC power supply, the device connection port is connected to the battery of the electric device, the RS485 logic communication device is configured to identify the battery type information connected, which are received by the first controller U1. Thus the first controller U1 can select and output the pulse signals based on the identified type information (herein the pulse signals may be the first pulse signal, the second pulse signal, and the third pulse signal), particularly output different pulse signals based on different battery types to control conduction of the second switch tube VT2. The amplitude values of the first regulator U2 fed back from the fifth resistor R5 and the first potentiometer RP1 is regulated, such that the first regulator U2 regulates the input electric energy to satisfy a desired charging electrical energy of the electric device connected to the device connection port. When it is necessary to manually adjust the charging capacity of the battery of the electric device, the first key switch S1 may be pressed, a resistor value of the second potentiometer RP2 is adjusted, so that when the battery power detected by the eighth resistor R8 and the ninth resistor R9 exceeds the threshold value (i.e., a desired battery power of the user) provided by the first power supply VCC1, the tenth resistor R10 and the second potentiometer RP2, the conduction of the first switch tube VT1 is controlled, the first power tube Q1 will be cut off, the charger will stop charging, then the charging time of the charger is detected by the first controller U1 in conjunction with the clock device. When the charging time is exceeded, the eighth IO end of the first controller U1 will adjust a degree of conduction of the second power tube Q2, and then adjust the threshold value provided by the second power supply VCC2, the eleventh resistor R11 and the twelfth resistor R12 (i.e., the battery power desired to be maintained for battery maintenance). When the charging time is exceeded but the power does not satisfy the threshold value provided by the second power supply VCC2, the eleventh resistor R11 and the twelfth resistor R12, the charging will be continued, until the threshold provided by the second power supply VCC2, the eleventh resistor R11 and the twelfth resistor R12 is satisfied, the first power tube Q1 will cut off, the charging stops, and the working information of the charger can be transmitted to the user's interoperable smart mobile device through the communication module 11, which can be queried and controlled by using a relevant APP. Specifically, for example, when the battery type identified by the charger based on the battery identification module is the lead-acid battery, since the lead-acid battery cannot be float-charged for long time, if the lead-acid battery is floated charged, that is, in the state of long term charging and not discharging, it is easy to form a sharp increase in internal resistance and a significant decline in capacity, which in turn affects the charging time and reduces its service life. At this time the charger may be used to detected, so that the power of the lead-acid battery in a certain range of slow charging and discharging cycle, so as to achieve the purpose of maintaining the battery. For the lithium battery, if it need to be storage for long term (more than one month), the best maintenance of the power is 40%˜60%, when it is storage up to a certain period of time, the battery power will be reduced, at this time the charger can always to replenish the power based on monitoring of the battery conditions, making the lithium battery maintain the power in the range of 40%˜60%. The user can use the relevant APP to view and control at any time, the intelligent control module of the charger cooperates with the communication module and establishes communication with the special APP of the charger to realize functions of APP. The functions of APP can be embodied in, for example, when setting up the maintenance, it can set up an approximate maintenance time based on usage habits (e.g., not using for 1-3 months or generally not using it in some seasons but using it in certain seasons, the charger can remember and learn such usage habits, and adjust the charge/discharge at any time to maximize the convenience of the user use it). In this way, if the set time is reached, the charger can send a notification to the user via the APP, so that the user can make a decision whether ready to use once fully charging, or continue to maintain. Of course, if the battery is ready to use at any time, the charger can be always controlled via the APP to fully charge the battery in advance for use at any time. Once the power is fully charged, the notification will be sent via the APP. If the user suddenly decides not to use it for a while, then it can be set to enter maintenance mode immediately. Of course, if no feedback is received within a certain period of time (this time can be the default or can be set to change, e.g., 1-2 days, while the charger will also remember and learn corresponding habits of the user) after being filled up, the charger can also automatically enter the maintenance mode, and at the same time, it will send the notification via the APP. Other types of the battery are also the same as described above, such charger can also identify the specific type of battery, and then carry out intelligent maintenance and charging and discharging.

It is apparent to a person of ordinary skill in the art that, the present disclosure is not limited to the details of the above-described exemplary embodiments, and that it is capable of being realized in other specific forms without departing from the spirit or essential features of the present disclosure. Accordingly, the embodiments should be regarded as exemplary and non-limiting from any point of view, and the scope of the present disclosure is limited by appended claims and not by the above description. Therefore the present disclosure is intended to encompass all variations falling within the meaning and scope of the equivalent elements of the claims, and any reference signs in the claims should not be regarded as limiting the claims to which they relate.

In addition, it should be understood that although this specification is described in accordance with the embodiments, no each embodiment contains only one independent technical solution, and this description of the specification is only for the sake of clarity, and the person of ordinary skill in the art should take the specification as a whole, and the technical solutions in the embodiments can be combined appropriately to form other embodiments that can be understood by the person of ordinary skill in the art.

What is claimed is:

1. An intelligent charger with battery charging and discharging maintenance unattended for long time, comprising a charging regulation module, a first feedback module, an output module, a charging control module, a second feedback module, a battery identification module, an intelligent control module, a feedback regulation module, a battery maintenance module, and a manual regulation module;
wherein the charging regulation module is configured to receive electrical energy, and a signal fed back from the first feedback module, and to perform a DC-DC regulation process on input electrical energy based on a feedback signal;
wherein the first feedback module is connected to the charging regulation module and configured to transmit electrical energy output from the charging regulation module and sample voltage and current of a transmitted electrical energy for outputting the first feedback signal;
wherein the output module is connected to the first feedback module and configured to receive electrical energy output from the first feedback module and transmit it to an electric device connected to the output module;
wherein the second feedback module is connected to the output module and configured to sample electrical energy of the output module in terms of voltage and output a second feedback signal;
wherein the battery identification module is connected to the output module and configured to, for the electric device connected to the output module, perform battery identification and output battery type information;
wherein the intelligent control module is connected to the feedback regulation module, the battery identification module, the second feedback module and the battery maintenance module, and is configured to,
output a first pulse signal, a second pulse signal and a third pulse signal;
select a pulse pattern to be input into the feedback regulation module based on battery type information received;
receive the second feedback signal;
determine electrical energy condition of the electric device connected to the output module;
set clock information;
output a fourth pulse signal; and
control operation of the battery maintenance module based on the clock information;
wherein the feedback regulation module is connected to the first feedback module, and configured to output a feedback regulation signal; change amplitude of the first feedback signal output by the first feedback module; receive the first pulse signal, the second pulse signal and the third pulse signal; and regulate amplitude of feedback signals;
wherein the battery maintenance module is connected to the second feedback module, and configured to, via a battery maintenance circuit, compare the second feedback signal and the fourth pulse signal those received, and output a first control signal;
wherein the manual regulation module is connected to the second feedback module and configured to manually regulate a battery threshold, compare a set battery threshold with the second feedback signal, and output a second control signal; and
wherein the charging control module is connected to the battery maintenance module and the manual regulation module, and configured to receive the first control signal and the second control signal, and control the DC-DC regulation process of the charging regulation module.

2. The intelligent charger with battery charging and discharging maintenance unattended for long time according to claim 1, wherein further comprises a communication module, configured to establish a wireless communication network with the intelligent control module and can interact with the intelligent control module for data; and the communication module is connected with the intelligent control module.

3. The intelligent charger with battery charging and discharging maintenance unattended for long time according to claim 2, wherein the charging regulation module comprises a power input port, a first capacitor, a second capacitor, a thermistor, a first regulator, a first power tube, a first diode, a second diode, a first inductor, a second resistor, and a third capacitor;
wherein a first end of the power input port is connected to one end of the first capacitor, one end of the second capacitor, a source of the first power tube, a second end and a third end of the first regulator;
wherein the other end of the second capacitor is connected to a fourteenth end of the first regulator;
wherein a six end of the first regulator is grounded via the thermistor;
wherein an eighth end of the first regulator is grounded via the second resistor and the third capacitor in turn;
wherein a grid of the first power tube is connected to a first end of the first regulator;
wherein a drain of the first power tube is connected to an anode of the first diode;
wherein a cathode of the first diode is connected to a cathode of the second diode and a first end of the first inductor;
wherein a second end of the first inductor is connected to an eleventh end of the first regulator and to the first feedback module;
wherein a second end of the power input port, the other end of the first capacitor, and a twelfth end and a thirteenth end of the first regulator are grounded; and
wherein an anode of the second diode is grounded.

4. The intelligent charger with battery charging and discharging maintenance unattended for long time according to claim 3, wherein the first feedback module comprises a third resistor, a fourth resistor, a fifth resistor, and a first potentiometer; the output module comprises a fourth capacitor and a device connection port;
wherein a first end of the third resistor is connected to one end of the fourth resistor and an eleventh end of the first regulator;
wherein a second end of the third resistor is connected to one end of the fourth resistor, a tenth end of the first regulator, a first end of the fifth resistor, one end of the fourth resistor, and a first end of the device connection port;
wherein a second end of the fifth resistor is connected to a ninth end of the first regulator, one end of the first potentiometer, and a slider; and
wherein the other end of the first potentiometer, the other end of the fourth capacitor, and a second end of the device connection port are grounded.

5. The intelligent charger with battery charging and discharging maintenance unattended for long time according to claim 4, wherein the battery identification module comprises a RS485 logic communication device, the intelligent control module comprises a first controller and a clock device, and the second feedback module comprises an eighth resistor and a ninth resistor;
wherein the RS485 logic communication device is configured to identify device battery information connected to the device connection port and connected to a first IO end and a second IO end of the first controller;
wherein the clock device is connected to a third IO end of the first controller; and
wherein one end of the eighth resistor is connected to the first end of the device connection port, the other end of the eighth resistor is connected to a fourth IO end of the first controller and grounded via the ninth resistor.

6. The intelligent charger with battery charging and discharging maintenance unattended for long time according to claim 5, wherein the feedback regulation module comprises a seventh resistor, a sixth resistor, a thirteenth resistor, and a second switch tube;
wherein one end of the seventh resistor is connected to the first IO end, the second IO end, and the third IO end of the first controller, the other end of the seventh resistor is connected to a first end of the thirteenth resistor and a base of the second switch tube;
wherein an emitter of the second switch tube and a second end of the thirteenth resistor are grounded; and
wherein a collector of the second switch tube is connected to a second end of the fifth resistor via the sixth resistor.

7. The intelligent charger with battery charging and discharging maintenance unattended for long time according to claim 5, wherein the manual regulation module comprises a first power supply, a tenth resistor, a second potentiometer, a first key switch, a first comparator, and a third diode; the charging control module comprises a first resistor and a first switch tube;
wherein the first power supply is connected to one end of the first key switch, and connected to an inverting end of the first comparator, one end of the second potentiometer and the slider via the tenth resistor; and the other end of second potentiometer is grounded;
wherein a non-inverting end of the first comparator is connected to a second end of the eighth resistor, a power supply of the first comparator is connected to the other end of the first key switch, and an output of the first comparator is connected to an anode of the third diode; and a cathode of the third diode is connected to a base of the first switch tube;
wherein an emitter of the first switch tube is connected to a grid of the first power tube via the first resistor; and
wherein a collector of the first switch tube is connected to a source of the first power tube.

8. The intelligent charger with battery charging and discharging maintenance unattended for long time according to claim 7, wherein the battery maintenance module comprises a second power supply, an eleventh resistor, a second power tube, a twelfth resistor, a second comparator, and a fourth diode;
wherein the second power supply is connected to a drain of the second power tube via the eleventh resistor;
wherein a grid of the second power tube is connected to an eighth IO end of the first controller, and a source of the second power tube is connected to an inverting end of the second comparator and grounded via the twelfth resistor; and
wherein a non-inverting end of the second comparator is connected to a second end of the eighth resistor, an output of the second comparator is connected to an anode of the fourth diode, and a cathode of the fourth diode is connected to a base of the first switch tube.
